(19) United States
(12) Patent Application Publication
(10) Pub. No.: US 2026/0019794 A1
(43) Pub. Date: Jan. 15, 2026

(54) METHOD FOR SELECTING GLOBAL ROAMING VIRTUAL SIM CARD WITHIN TERMINAL AND TERMINAL THEREFOR

(71) Applicant: Shanghai TUGE Data Technologies Co., Ltd., Shanghai (CN)

(72) Inventors: Kaihang WANG, Shanghai (CN); Hao ZHOU, Shanghai (CN)

(73) Assignee: Shanghai TUGE Data Technologies Co., Ltd., Shanghai (CN)

(21) Appl. No.: 18/881,739

(22) PCT Filed: May 12, 2023
(86) PCT No.: PCT/CN2023/093881

§ 371 Date: Jan. 7, 2025

(30) Foreign Application Priority Data
Jul. 7, 2022 (CN) 202210791277.5

(51) Int. Cl. H04W 8/06; H04W 4/60; H04W 8/20; H04W 60/00

(52) U.S. Cl. CPC H04W 8/06; H04W 4/60; H04W 8/205; H04W 60/00

(57) ABSTRACT

A method for selecting a global roaming virtual subscriber identity module (SIM) card within a terminal, and a terminal therefor are provided. Within the terminal, a specific number of local virtual SIM cards from different operators are shared, that is, the bootstrap SIM cards. Prior to interaction between the terminal and a server based on a local virtual SIM card within the terminal after startup, the terminal checks whether registration record information of at least one local virtual SIM card within a region where the terminal resides is stored in the terminal; in the case that the registration record information is stored, the terminal selects a first local virtual SIM card that is successfully registered to interact with the server; and the terminal receives remote virtual SIM card information delivered by the server.

### CROSS-REFERENCE TO THE RELATED APPLICATIONS

This application is the national phase entry of International Application No. PCT/CN2023/093881, filed on May 12, 2023, which is based upon and claims priority to Chinese Patent Application No. 202210791277.5, filed on Jul. 7, 2022, the entire contents of which are incorporated herein by reference.

### TECHNICAL FIELD

Embodiments of the present disclosure relate to the technical field of communications, and in particular, relate to a method for selecting a global roaming virtual SIM card within a terminal, and a terminal therefor.

### BACKGROUND

The related art provides a signal switching method, as described in CN107567013. In the technical solution disclosed in CN107567013, in response to moving from a second country to a first country, a terminal determines its current geographic location as the first country based on a mobile country code (MCC) carried in a cell system message of a current network; and in the case that the current communication signal of the terminal is not a communication signal of the first country, the terminal switches its current communication signal to a communication signal of a virtual subscriber identity module (SIM) card corresponding to the first country, wherein the terminal has pre-purchased communication data services for the first country. In this way, the country where the terminal resides is determined based on the MCC, and the terminal is automatically switched to the communication data services of the country, thereby ensuring continuity of communication data.

In the above solution, the switching to the communication signal of the virtual SIM card for the first country uses a random switching method with a global roaming virtual SIM card. However, this method has the following drawbacks: the randomly selected local global roaming virtual SIM card may fail to register in the first country after activation. As a result, a plurality of local global roaming virtual SIM cards may be needed for registration attempts before a successful registration on the network. This prolongs the process of replacing the regional long-term remote virtual SIM card, leading to an extended registration time, increased likelihood of conflicts, and lower operational efficiency.

### SUMMARY

To solve the problem in the related art, at least one embodiment of the present disclosure provides a method for selecting a global roaming virtual SIM card within a terminal, and a terminal, to reduce startup and registration time of a local virtual SIM card, that is, a bootstrap SIM card, better lower the probability of conflicts, and improve the service efficiency.

In an aspect, some embodiments of the present disclosure provide a method for selecting a global roaming virtual SIM card within a terminal, applicable to the terminal. The method includes:
S1, prior to interaction between the terminal and a server based on a local virtual SIM card within the terminal after startup, checking whether registration record information of at least one local virtual SIM card within a region where the terminal resides is stored in the terminal, wherein a specified number of local virtual SIM cards of various operators are stored in the terminal;
S2, in the case that the registration record information is stored, selecting a first local virtual SIM card corresponding to a successful registration based on the registration record information to interact with the server;
S3, receiving remote virtual SIM card information for registration within a region to which the terminal currently belongs from the server within a specified time period, wherein the remote virtual SIM card information is delivered by the server based on the first local virtual SIM card; and
S4, determining whether the remote virtual SIM card information is successfully received within the specified time period, and updating registration record information of the first local virtual SIM card based on information indicating whether the remote virtual SIM card information is successfully received;
wherein the registration record information is stored in a specified format and includes a registration time, an indicator indicating whether registration is successful, a region to which the terminal belongs, an identifier of a local virtual SIM card, and a successfully registered public land mobile network (PLMN), the local virtual SIM card is a bootstrap SIM card shared by a plurality of terminals; and the registration record information of the first local virtual SIM card is record information indicating whether a terminal using the first local virtual SIM card is successfully registered based on the first local virtual SIM card within the specified time period.

In practical applications, multiple local virtual SIM cards may serve as local virtual SIM cards belonging to different operators and shared by multiple terminals. The successfully registered PLMN facilitates acceleration of registration for a next time.

In some embodiments, the method further includes: S2a, in the case that the registration record information is not present, randomly selecting a local virtual SIM card as the first local virtual SIM card to interact with the server, and performing S3 and S4;

wherein in S4, the terminal stores the registration information of the first local virtual SIM card based on the information indicating whether the remote virtual SIM card information is successfully received within the specified time period;

In some embodiments, in the case that in S4 the terminal has not successfully received the remote virtual SIM card information within the specified time period, the method further includes:

reselecting the first local virtual SIM card corresponding to the successful registration based on the registration record information to interact with the server, and performing S3 and S4.

In some embodiments, the method further includes:
in the case that local virtual SIM cards corresponding to all successful registrations the registration record information interact with the server but the remote virtual SIM card information fails to be downloaded, selecting a local virtual SIM card from other local virtual SIM cards as a first virtual SIM card to interact with the server; and
clearing registration record information of all local virtual SIM cards within the region where the terminal resides.

In some embodiments, the method further includes:
in the case that all local virtual SIM cards within the region where the terminal resides have registration record information, and the registration record information all indicate unsuccessful registrations, randomly selecting a local virtual SIM card within the region where the terminal resides as a first virtual SIM card to interact with the server; and clearing registration record information of all local virtual SIM cards within the region where the terminal resides; or
in the case that part of local virtual SIM cards within the region where the terminal resides have registration record information, and the registration record information all indicate unsuccessful registrations, excluding local virtual SIM cards corresponding to the unsuccessful registrations, and randomly selecting a local virtual SIM card from remaining local virtual SIM cards within the region where the terminal resides as a first virtual SIM card to interact with the server; and clearing registration record information of the local virtual SIM cards corresponding the unsuccessful registrations.

In some embodiments, the identifier of the local virtual SIM card includes an international mobile subscriber identity (IMSI); the registration time includes a time point of successfully registering with the PLMN; and additionally, the registration time may also include a total duration for registration;
the registration record information is classified based on the region where the terminal resides, and local virtual SIM cards within any region are categorized based on priorities, a local virtual SIM card with a top priority is a local virtual SIM card that is successfully registered within a first time period associated with a current time point, and a local virtual SIM card with a second-highest priority is a local virtual SIM card with a successful registration within a second time period associated with the current time point; and
correspondingly, S2 includes:
selecting a first local virtual SIM card with the top priority corresponding to the successful registration based on the registration record information to interact with the server.

In some embodiments, the method further includes:
periodically checking whether registration record information that exceeds a first predetermined time period is present within a region, and deleting the registration record information that exceeds the first predetermined time period within the region in the case that the registration record information that exceeds the first predetermined time period is present. The first predetermined time period herein may be understood as a validity period of the registration record information or a validity period for using the records.

In some embodiments, the method further includes:
receiving configuration information sent by the server for configuring the registration record information, and configuring registration record information within the terminal based on the configuration information, such that the local virtual SIM card in the terminal carries priority information, wherein the configuration information carries the priority information of the local virtual SIM card; wherein
the priority information includes an identifier of a local virtual SIM card with a top priority and an identifier of a local virtual SIM card with a second-highest priority, wherein the identifier of the local virtual SIM card with the top priority is an identifier of a local virtual SIM card recorded by the server that has achieved a successful registration through interaction with the server and has a shortest interaction time.

In the case that there is no priority information for local virtual cards in the terminal, the terminal may configure priority information for all local virtual cards in the terminal based on the configuration information delivered by the server. Additionally, in the case that priority information for local virtual cards is present in the terminal and the terminal has received configuration information from the server, the terminal may update the priority information for all local virtual cards in the terminal based on the configuration information delivered by the server.

In the case that priority information for local virtual cards is present in the terminal, in S2, a first local virtual SIM card with a top priority corresponding to the successful registration based on the registration record information to interact with the server.

In some embodiments, a plurality of local virtual SIM cards are stored in the terminal; and/or
a management system to which all local virtual SIM cards belong filters registration record information of all terminals managed by the management system, and delivers filtered valid registration record information to terminals that use some or all of the local virtual SIM cards.

In another aspect, some embodiments of the present disclosure further provide a terminal. The terminal includes a memory and a processor;
wherein one or more programs are stored in the memory, and the processor is configured to load and run the one or more programs stored in the memory to cause the terminal to perform the method according to the first aspect.

In still another aspect, some embodiments of the present disclosure further provide a computer-readable storage medium. The computer-readable storage medium is configured to store one or more computer programs. The one or more computer programs, when loaded and run by one or more processors, cause the one or more processors to perform the method according to the first aspect.

Therefore, the registration record information of the local virtual SIM card is pre-stored. Therefore, based on the registration record information, the terminal may use the best local virtual SIM card for quick registration, and thus successfully switches to an appropriate regional long-term remote virtual SIM card. This improves service efficiency while increasing the success rate and speed of network registration.

In particular, in the embodiments of the present disclosure, the method of optimally selecting the local virtual SIM card reduces the time for startup and registration, better reduces the probability of conflicts in the prior art, and improves the service efficiency.

In the embodiments, the registration record information contains the registration success information of the local virtual card, and also includes the priority of the local virtual card. As a result, when the terminal makes a call, the local virtual card is selected based on priority, which improves the selection efficiency and the success rate of network registration.

### BRIEF DESCRIPTION OF THE DRAWINGS

For clearer descriptions of the technical solutions according to the embodiments of the present disclosure or the technical solutions in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is a schematic flowchart of a method for selecting a global roaming virtual SIM card within a terminal according to some embodiments of the present disclosure;

FIG. 2 is a schematic flowchart of a method for switching from the prior solution to the method according to the present disclosure; and

FIG. 3 is a schematic flowchart of a method for selecting a global roaming virtual SIM card within a terminal according to some embodiments of the present disclosure.

### DETAILED DESCRIPTION OF THE EMBODIMENTS

For clearer descriptions of the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

It should be noted that, in this specification, such relationship-related terms as “first” and “second” are only used to differentiate one entity or operation from another entity or operation, but are not intended to require or imply that there is a practical relationship or sequence between these entities or operations.

In the prior art, a regional long-term remote virtual SIM card may become unusable or encounter abnormalities, and consequently a global roaming virtual SIM card that is stored locally needs to be restarted. Since the current approach involves randomly selecting a virtual SIM card, the selected global roaming virtual SIM card may still fail to register in the current country or may take a long time to register after activation. In some cases, it is also possible that multiple global roaming virtual SIM cards may need to be switched and may attempts are made before a successful registration on the network. This results in a lengthy process for replacing the regional long-term remote virtual SIM card, leading to lower business efficiency

Currently, a locally stored global roaming virtual SIM card is generally used as a bootstrap SIM card. In the case that the regional long-term remote virtual SIM card in the terminal cannot be used or is faulty, a new locally stored global roaming virtual SIM card is typically restarted to connect to the server for replacement. The embodiments of the present disclosure mainly provide an algorithm for quickly selecting a local roaming virtual SIM card in such scenarios, enabling the terminal to quickly select an optimal locally-stored global roaming virtual SIM card, thereby facilitating a rapid registration and replacement with a suitable regional long-term remote virtual SIM card.

A globally roaming local virtual SIM card (referred to as a local virtual SIM card, a local roaming virtual SIM card, a global roaming SIM card, a bootstrap SIM card, or a roaming virtual SIM card) is a virtual SIM card pre-stored locally within a terminal. The virtual SIM card has global roaming capabilities and is used exclusively for a roaming registration to download “local available” regional remote virtual SIM cards. Multiple devices/terminals may share the same batch of globally roaming local virtual SIM cards.

A regional long-term remote virtual SIM card (referred to as a remote virtual SIM card) is a virtual SIM card issued by a virtual SIM card server and stores local information. This virtual SIM card enables roaming within the current region.

In the related art, each time a device/terminal is powered on for the first time or after every restart, the device/terminal needs to randomly select and use a local global roaming virtual SIM card for registration and network connection with a remote virtual SIM card server, and obtain and download, via the remote virtual SIM card server, a regional long-term remote virtual SIM card to the device/terminal. In the embodiments of the present disclosure, usage records, including the time and current country of the previously used local global roaming virtual SIM cards, are stored. This allows for an optimal selection of the local global roaming virtual SIM card for a next time where necessary, thereby improving the success rate and speed of network registration.

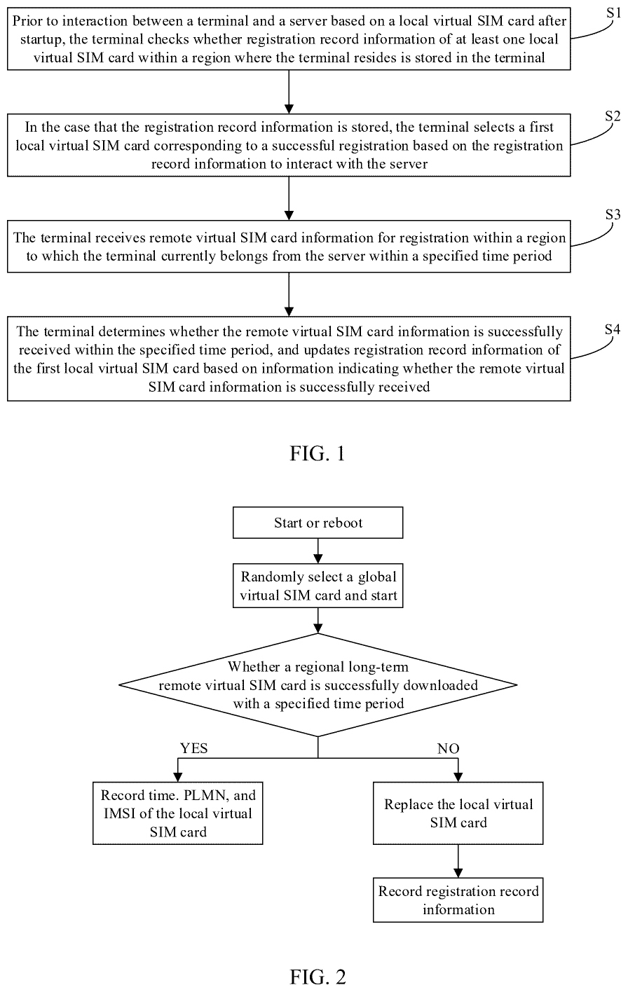

As illustrated in FIG. 1, some embodiments of the present disclosure provide a method for selecting a global roaming virtual SIM card within a terminal. The method is performed by a terminal storing a plurality of virtual SIM cards. The method includes the following steps.

In S1, prior to interaction between the terminal and a server based on a local virtual SIM card within the terminal after startup, the terminal checks whether registration record information of at least one local virtual SIM card within a region where the terminal resides is stored in the terminal.

In practical applications, the current region of the terminal may refer to the country where the terminal resides. Based on a country code in the registration record information, registration record information of at least one local virtual SIM card applicable to the current country code may be determined.

Typically, the registration record information includes data such as the registration time, an indicator indicating whether registration is successful, a region to the terminal belongs, the identifier of the local virtual SIM card, and the information of the PLMN that the terminal is successfully registered with. The indicator may include a success indicator or a failure indicator. Additionally, the registration record information may include other specified information, for example, priority information. The embodiments set no restrictions on this, and configuration is made based on actual needs.

Moreover, in practical applications, the registration record information may be stored in a specified format.

In S2, in the case that the registration record information is stored, the terminal selects a first local virtual SIM card corresponding to a successful registration based on the registration record information to interact with the server.

In S3, the terminal receives remote virtual SIM card information for registration within a region to which the terminal currently belongs is from the server within a specified time period, wherein the remote virtual SIM card information is delivered by the server based on the first local virtual SIM card.

The terminal may be connected to the network based on the successfully received remote virtual SIM card information, such that the switching of the current communication signal of the terminal is implemented, or the terminal is connected to the network upon startup and acquires a communication signal.

In S4, the terminal determines whether the remote virtual SIM card information is successfully received within the specified time period, and updates registration record information of the first local virtual SIM card based on information indicating whether the remote virtual SIM card information is successfully received.

In this embodiment, the local virtual SIM card may be referred to as a “bootstrap SIM card.” The switching process of the bootstrap SIM card may employ a conventional switching method. However, in the related art, due to the random selection of the bootstrap SIM card, there are deficiencies such as low service efficiency and a low network registration success rate. In the embodiments, by pre-storing the registration record information of the local virtual SIM card, the terminal may use the best local virtual SIM card for rapid registration based on the registration record information, thereby successfully switching to the appropriate regional long-term remote virtual SIM card. This improves service efficiency and increases the network registration success rate and speed.

Typically, the local virtual SIM card may be a bootstrap SIM card shared by multiple terminals. Therefore, regarding the registration record information in step S1, the following explanation is provided:

For a specific bootstrap SIM card, such as the first local virtual SIM card, the registration record information of the first local virtual SIM card may be the record information indicating whether the terminals using the first local virtual SIM card is successfully registered within during a specified time period. In this case, the terminals using the first local virtual SIM card may be two or more terminals.

In practice, the management system of all bootstrap SIM card cards filters the registration record information of all terminals managed by the system, and delivers the filtered valid registration record information to the terminals that use some or all of the bootstrap SIM card cards.

The “valid registration record information” herein refers to the registration records that are within the validity period, such as records valid for one week, one month, three months, or the like.

Typically, the registration record information may be classified and stored according to regional identifiers. For easy search, the search process may be performed based on the region to which the terminal belongs.

In the embodiments of the present disclosure, the conflict of usage of local virtual SIM card registration may be effectively avoided. The present disclosure provides an optimized registration method that significantly shortens the registration time between the terminal and the server, improves service efficiency, and enhances the user experience.

In addition, some embodiments of the present disclosure further provide a method for selecting a global roaming virtual SIM card within a terminal. The method is performed by a terminal storing a plurality of virtual SIM cards. The method may include the following steps.

In 101, prior to interaction between the terminal and a server based on a local virtual SIM card within the terminal after startup, the terminal checks whether registration record information of at least one local virtual SIM card within a region where the terminal resides is stored in the terminal; the terminal performs step 102 in the case that the registration record information is stored in the terminal; and otherwise, the terminal performs step 102a.

In the embodiments, the registration record information may be stored in a specified format and includes: a registration time, a success/failure indicator of registration, a region to which the terminal belongs, priority information, an identifier of a local virtual SIM card, and other relevant information.

The local virtual SIM card identifier includes an IMSI; and the registration time includes a time point of a successful PLMN registration; In addition, the registration time may further include a registration duration of the local virtual SIM card. The success/failure indicator of registration includes: a success registration indicator and a failure registration indicator (such as an error code).

Generally, the registration record information is classified based on the region to which the terminal belongs, and local virtual SIM cards within any region are categorized based on priorities, a bootstrap SIM card with a top priority is a bootstrap SIM card that is successfully registered within a first time period associated with a current time point, and a bootstrap SIM card with a second-highest priority is a bootstrap SIM card that is successfully registered within a second time period associated with the current time point; and so on. For example, the bootstrap SIM card that is successfully registered within one week prior to the current time point has the top priority. The bootstrap SIM card that is successfully registered within two weeks prior to the current time point (excluding the week with the top priority) has the second-highest priority. The bootstrap SIM card that successfully registered within the three weeks prior to the current time point (excluding the time periods with the top and second-highest priorities) has a third-highest priority, and so on.

In 102, in the case that the registration record information is stored, the terminal selects a first local virtual SIM card corresponding to a successful registration based on the registration record information to interact with the server.

Specifically, a first local virtual SIM card with the top priority corresponding to the successful registration is selected based on the registration record information to interact with the server. In the case that there is no first local virtual SIM card with the top priority, a first local virtual SIM card with the second-highest priority is selected to interact with the server.

In 103, the terminal receives remote virtual SIM card information for registration within a region to which the terminal currently belongs from the server within a specified time period, wherein the remote virtual SIM card information is delivered by the server based on the first local virtual SIM card.

The process that the server delivers the remote virtual SIM card based on the first local virtual SIM card is consistent with the process performed by the server in the related art, which is thus not described herein any further.

In 104, the terminal determines whether the remote virtual SIM card information is successfully received within the specified time period, and updates registration record information of the first local virtual SIM card based on information indicating whether the remote virtual SIM card information is successfully received. In the case that the remote virtual SIM card information is successfully received, the terminal updates the registration record information of the first local virtual SIM card. In the case that there is no registration record information of the first local virtual SIM card, the registration record information of the first local virtual SIM card may be directly stored.

In 102a, in the case that the registration record information is not present, the terminal randomly selects a local virtual SIM card as the first local virtual SIM card to interact with the server, and performs step 103 and step 104.

That is, in the case that the registration record information is not present, the terminal randomly selects a local virtual SIM card as the first local virtual SIM card to interact with the server.

In the case that the registration record information all indicate an unsuccessful registration, a local virtual SIM card may be randomly selected as the first local virtual SIM card to interact with the server.

In 105, in the case that in 104, the terminal has not successfully received the remote virtual SIM card information within the specified time period, the terminal selects a second local virtual SIM card corresponding to a successful registration based on the registration record information to interact with the server, and performs step 103 and step 104.

In 106, in the case that local virtual SIM cards corresponding to all successful registrations the registration record information interact with the server but the remote virtual SIM card information fails to be downloaded, the terminal selects a local virtual SIM card from other local virtual SIM cards to interact with the server; and
clears registration record information of all local virtual SIM cards within the region where the terminal resides. It should be noted that, in this case, the terminal clears the stored registration record information for the local virtual SIM cards corresponding to the region where the terminal desires. In the case that the terminal is one of the terminals managed by the management system, the terminal does not need to clear the registration record information in the management system. After the terminal performs the clearing action, the cleared information may be reported to the management system, such that the management system updates the registration record information within the system.

In 107, the terminal periodically checks whether registration record information that exceeds a first predetermined time period is present within a region, and deletes the registration record information that exceeds the first predetermined time period (that is, the validity period) within the region in the case that the registration record information that exceeds the first predetermined time period is present.

Alternatively, in other embodiments, the terminal may further receive configuration information sent by the server for configuring the registration record information, and configures registration record information within the terminal based on the configuration information, wherein the configuration information carries the priority information of the local virtual SIM card. For example, the priority information may include an identifier of a bootstrap SIM card with a top priority and an identifier of a bootstrap SIM card with a second-highest priority, wherein the identifier of the bootstrap SIM card with the top priority is an identifier of a bootstrap SIM card recorded by the server that has achieved a successful registration through interaction with the server and has a shortest interaction time, and the interaction time of the bootstrap SIM card with second-highest priority follows the interaction time of the bootstrap SIM card with the top priority. In the case that the priority information of a local virtual SIM card recorded in the terminal is different from the priority information of the same local virtual SIM card in the configuration information delivered by the server, the priority information may be updated based on the configuration information delivered by the server, that is, the priority information configured by the server takes precedence.

In the embodiments, the registration record information contains the registration success information of the local virtual card, and also includes the priority of the local virtual card. As a result, when the terminal makes a call, the local virtual card is selected based on priority, which improves the selection efficiency and the success rate of network registration.

In other embodiments, in the case that all local virtual SIM cards within the region where the terminal resides have registration record information, and the registration record information all indicate unsuccessful registrations (that is, error code records), the terminal randomly selects a local virtual SIM card within the region where the terminal resides as a first virtual SIM card to interact with the server; and clears registration record information of all local virtual SIM cards within the region where the terminal resides;

In another possible implementation, in the case that part of local virtual SIM cards within the region where the terminal resides have registration record information, and the registration record information all indicate unsuccessful registrations, the terminal excludes local virtual SIM cards corresponding to the unsuccessful registrations, and randomly selects a local virtual SIM card from remaining local virtual SIM cards within the region where the terminal resides as a first virtual SIM card to interact with the server; and clears registration record information of the local virtual SIM cards corresponding the unsuccessful registrations.

To better understand the method of the present disclosure, the following description explains the process illustrated in FIG. 2. In FIG. 2, the process of selecting a local virtual SIM card to start a connection to the server is the same as in the existing process. Based on the existing solution, the embodiments of the present disclosure add a step of recording the registration record information. In the conventional solution, upon power-on or reboot, the terminal randomly selects a global local virtual SIM card within the region where the terminal resides to start registration. Upon successful registration, the terminal is connected to the remote virtual SIM card server and successfully downloads a regional long-term remote virtual SIM card that is registrable in the region. In the embodiments, the terminal records the PLMN, time, and IMSI of the global local virtual SIM card during the registration process.

In the case that the local virtual SIM card selected by the terminal fails to successfully connect to the remote virtual SIM card server or fails to download the regional long-term remote virtual SIM card within a specified period of time, the terminal records error code information (such as time, IMSI, error messages, or the like), and then randomly selects another global local virtual SIM card to retry.

Therefore, in the case that the terminal needs to start the global local virtual SIM card for a next time, an optimal global local virtual SIM card may be selected, i.e., prioritizing a global local virtual SIM card that is successfully registered for registration. Furthermore, the prioritized global local virtual SIM card writes the registered PLMN (the PLMN that the terminal is registered with during the last shutdown or network disconnection) into its registered PLMN (RPLMN), thereby accelerating the registration process. The RPLMN refers to the PLMN that the terminal has registered with before the last shutdown or network disconnection. The registered PLMN may be added to the RPLMN. Specifically, the RPLMN of the current SIM card may be modified by writing to the card file before activation.

The processes described in the embodiments of the present disclosure may be understood as first filtering local virtual SIM cards corresponding to the region/country where the terminal resides. Then, from the filtered local virtual SIM cards, the registration record information is checked, and the local virtual SIM card corresponding to the successful registration information is selected to interact with the server.

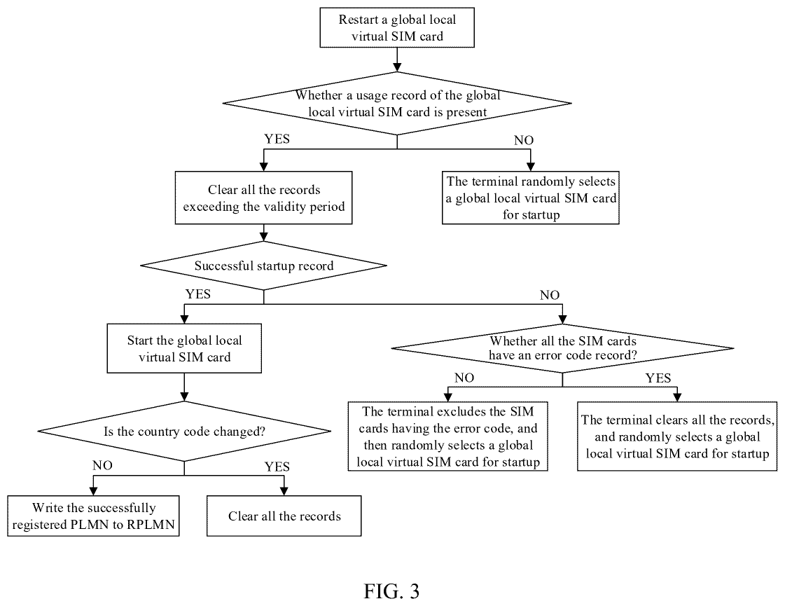

By the process illustrated in FIG. 3 below, the registration record information of local virtual SIM cards may be first filtered, and then a local virtual SIM card corresponding to the region/country where the terminal resides is selected based on the successful registration information to interact with the server. A method for selecting a global roaming virtual SIM card within a terminal illustrated in FIG. 3 specifically includes the following steps.

Step 1: For any global local virtual SIM card that needs to be re-registered on the terminal, whether there are usage records for the global local virtual SIM card (i.e., registration record information) is checked. In the case that there are usage records, Step 2 is performed; and otherwise, the terminal randomly selects a global local virtual SIM card for startup.

Step 2: The terminal also checks whether the usage records of the global local virtual SIM card are within a validity period (i.e., whether the registration record information is within a first predetermined time period). In the case that the records exceed the validity period, all usage records that have surpassed the saved time are cleared.

Step 3: The terminal checks whether there is any successful startup record (i.e., successful registration information in the registration record) from the usage records within the validity period. In the case that there is a successful startup record, the local virtual SIM card corresponding to the successful startup record is selected.

Step 4: Whether the country code of the selected local virtual SIM card belongs to the country code of the terminal is checked. In the case that the country code of the selected local virtual SIM card belongs to the country code of the terminal, the card is started, and the successfully registered PLMN is written into the RPLMN. Otherwise, all the records are deleted.

In Step 3, in the case that there are no successful startup records (i.e., all SIM cards have error code records), the terminal randomly selects a global local virtual SIM card within the region where the terminal resides for startup, and clears all error code records. The random selection may be made by excluding the local virtual SIM cards with error code records and choosing from the remaining global local virtual SIM cards within the region where the terminal resides. In the case that all global local virtual SIM cards within the region where the terminal resides have error code records, all records may be cleared, and a global local virtual SIM card may be randomly selected from all the global local virtual SIM cards within the region where the terminal resides.

In the embodiments, the registration record information of the local virtual SIM card is pre-stored. Therefore, based on the registration record information, the terminal may use the best local virtual SIM card for quick registration, and thus successfully switches to an appropriate regional long-term remote virtual SIM card. This improves service efficiency while increasing the success rate and speed of network registration.

In addition, some embodiments of the present disclosure further provide a terminal. The terminal includes a memory and a processor; wherein one or more programs are stored in the memory, and the processor is configured to load and run the one or more programs stored in the memory to cause the terminal to perform the method according to any one of the above embodiments.

In practical applications, the terminal according to the embodiments may include at least one processor, at least one memory, at least one network interface, and/or other user interfaces. The components in the terminal are coupled together via a bus system. It may be understood that the bus system is configured to implement connections and communications between these components. In addition to a data bus, the bus system may further include a power bus, a control bus, and a state signal bus.

In the embodiments, the terminal may perform the methods as illustrated in FIG. 1 to FIG. 2. The user interface may include a display, a keyboard or keypad, or a click or tap device (for example, a mouse or a touch panel).

It may be understood that the memory may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM), which serves as an external high-speed cache. Through exemplary but not limitative description, many forms of RAMs may be used, for example, a static random-access memory (SRAM), a dynamic random-access memory (DRAM), a synchronous dynamic random-access memory (SDRAM), a double data speed synchronous dynamic random-access memory (DDR SDRAM), an enhanced synchronous dynamic random-access memory (ESDRAM), a synchronous dynamic random-access memory (SLDRAM), and a direct rambus dynamic random-access memory (DR RAM). The memory described herein is intended to include, but is not limited to, these memories and any other suitable types of memories.

In some embodiments, the memory stores the following elements: executable units or data structures, or subsets thereof, or extension sets thereof; an operating system, and an application.

The operating system includes various system programs, for example, framework layers, core layers, drive layers, and the like, for implementing various infrastructure services and processing hardware-based tasks. The application includes various applications, for example, media players, browsers, and the like, for implementing various application services. The programs for implementing the methods according to the embodiments of the present disclosure may be included in the application.

In the embodiments of the present disclosure, the processor, when loading and executing programs or instructions stored in the memory (or the programs and instructions stored in the application), is caused to perform the steps of the methods according to the first aspect.

The methods according to the embodiments of the present disclosure may be applicable to the processor or may be implemented by the processor. The processor may be an integrated circuit chip, and has capabilities of processing signals. During the implementation, various steps in the above method may be performed by means of an integrated logic circuit in the processor or by means of instructions. The processor may be a general processor, a digital signal processor (DSP), an application specific integrated circuit (ASIC), a field programmable gate array (FPGA) or another programmable logic device, a discrete gate or transistor logic device, or a discrete hardware component. The processor is capable of implementing or performing the methods, steps and logic block diagrams in the embodiments of the present disclosure. The general-purpose processor may be a microprocessor or any customary processor or the like. The steps in the method according to the embodiments of the present disclosure may be directly reflected as being practiced by a decoding processor, or practiced by a software unit plus hardware in the decoding processor in the decoding processor. The software unit may be located in a random memory, a flash memory, a read-only memory, a programmable read-only memory, an electrically erasable programmable memory, a register or the like storage medium commonly known in the art. The storage medium is within the memory. The processor reads the information stored in the memory and performs the steps of the above method in combination with the hardware thereof.

In another aspect, an embodiment of the present disclosure further provides a computer-readable storage medium storing one or more computer programs therein, wherein the one or more computer programs, when loaded and run on a processor, causes the processor to perform the method according to any of the above embodiments.

It may be understood that the embodiments herein may be practiced by hardware, software, firmware, middleware, microcode or a combination thereof. For practice of hardware, the processing unit may be practiced in one or more application-specific integrated circuits (ASICs), digital signal processors (DSPs), digital signal processing devices (DSPDs), programmable logic devices (PLDs), field programmable gate arrays (FPGAs), general-purpose processors, controllers, micro-controllers, microprocessors, or other electronic units or a combination thereof for performing the above-described methods.

For implementation in terms of software, the technical solutions according to the present disclosure may be implemented by performing the functional units herein. The software code may be stored in the memory and executed by the processor. The memory may be implemented in the processor or outside the processor.

A person skilled in the art may envisage that various exemplary units and algorithm steps described with reference to the embodiments of the present disclosure given herein may be practiced in the form of electronic hardware or a combination of computer software and electronic hardware. Whether such functions are implemented in the form of software or hardware depends on the specific application of the technical solutions and the design restrictions. Professional technical personnel may implement the described functions by using different methods for each specific application. However, such implementation shall not be deemed as going beyond the scope of the present disclosure.

A person skilled in the art would clearly acknowledge that for ease and brevity of description, the specific operation processes of the above described systems, apparatuses and units may be referenced to the relevant portions in the above described method embodiments, which are thus not described herein any further.

It should be understood that the steps according to the embodiments of the present disclosure, unless otherwise specified, are performed in any order according to actual needs. The disclosed apparatus and method may be practiced in other manners. The above described device embodiments are merely illustrative. For example, the unit division is merely logical function division and may be other divisions in actual practice. For example, multiple units or components may be combined or integrated into another device, or some features can be ignored or not performed. In addition, the displayed or discussed mutual couplings or direct couplings or communication connections may be implemented through some interfaces. The indirect couplings or communication connections between the devices or units may be implemented in electronic, mechanical or other forms.

The units which are described as separate components may be physically separated or may be not physically separated, and the components which are illustrated as units may be or may not be physical units, that is, the components may be located in the same position or may be distributed into a plurality of network units. Some of or all of the units may be selected according to actual needs to achieve the objectives of the solutions of the embodiments.

In addition, functional units in the embodiments of the present disclosure may be integrated into one processing unit, or each of the units may exist along physically, or two or more units may be integrated into one unit.

In the case that the functions are implemented in a form of a software functional unit and sold or used as an independent product, the units may be stored in a computer readable storage medium. Based on such understanding, the technical solutions of the present disclosure essentially, or the part contributing to the related art, or a part of the technical solutions may be implemented in a form of a software product. The computer software product is stored in a storage medium and includes several instructions to cause a computer device (which may be a personal computer, a server, a network device, or the like) to perform all or some of steps of the methods described in the embodiments of the present disclosure.

It should be noted that, in this specification, terms “comprises,” “include,” “contain,” and any other variations thereof are intended to cover a non-exclusive inclusion, such that a process, method, article, or apparatus, that comprises, has, includes, or contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus.

In addition, those skilled in the art shall understand that, although some embodiments described herein include some features included in other embodiments, rather than other features, a combination of the features in different embodiments signifies that the features are within the scope of the present disclosure and different embodiments may be derived.

Although some exemplary embodiments of the present disclosure are described with reference to the accompanying drawings, a person skilled in the art would make various modifications and variations without departing from the spirit and the scope of the present disclosure. Such modifications and variations shall be considered as falling within the scope defined by the appended claims.

What is claimed is:

1. A method for selecting a global roaming virtual subscriber identity module (SIM) card within a terminal, applicable to the terminal, the method comprising:
S1, prior to interaction between the terminal and a server based on a local virtual SIM card within the terminal after startup, checking whether registration record information of at least one local virtual SIM card within a region where the terminal resides is stored in the terminal, wherein a specified number of local virtual SIM cards of various operators are stored in the terminal;
S2, in a case that the registration record information is stored, selecting a first local virtual SIM card corresponding to a successful registration based on the registration record information to interact with the server;
S3, receiving remote virtual SIM card information for registration within a region where the terminal currently belongs from the server within a specified time period, wherein the remote virtual SIM card information is delivered by the server based on the first local virtual SIM card; and
S4, determining whether the remote virtual SIM card information is successfully received within the specified time period, and updating registration record information of the first local virtual SIM card based on information indicating whether the remote virtual SIM card information is successfully received;
wherein the registration record information is stored in a specified format and comprises a registration time, an indicator indicating whether registration is successful, a region where the terminal belongs, an identifier of a local virtual SIM card, and a successfully registered public land mobile network (PLMN), the local virtual SIM card is a bootstrap SIM card shared by a plurality of terminals; and the registration record information of the first local virtual SIM card is record information indicating whether a terminal using the first local virtual SIM card is successfully registered based on the first local virtual SIM card within the specified time period.

2. The method according to claim 1, further comprising:
S2a, in a case that the registration record information is not present, randomly selecting a local virtual SIM card as the first local virtual SIM card to interact with the server, and performing S3 and S4;
wherein in S4, the terminal stores registration information of the first local virtual SIM card based on the information indicating whether the remote virtual SIM card information is successfully received within the specified time period.

3. The method according to claim 1, wherein in a case that in S4 the terminal has not successfully received the remote virtual SIM card information within the specified time period, the method further comprises:
reselecting the first local virtual SIM card corresponding to the successful registration based on the registration record information to interact with the server, and performing S3 and S4.

4. The method according to claim 3, further comprising:
in a case that local virtual SIM cards corresponding to all successful registrations the registration record information interact with the server but the remote virtual SIM card information fails to be downloaded, selecting a local virtual SIM card from other local virtual SIM cards as a first virtual SIM card to interact with the server; and clearing registration record information of all local virtual SIM cards within the region where the terminal resides.

5. The method according to claim 1, further comprising:
in a case that all local virtual SIM cards within the region where the terminal resides have registration record information, and the registration record information all indicate unsuccessful registrations, randomly selecting a local virtual SIM card within the region where the terminal resides as a first virtual SIM card to interact with the server; and clearing registration record information of all local virtual SIM cards within the region where the terminal resides;
or
in a case that part of local virtual SIM cards within the region where the terminal resides have registration record information, and the registration record information all indicate unsuccessful registrations, excluding local virtual SIM cards corresponding to the unsuccessful registrations, and randomly selecting a local virtual SIM card from remaining local virtual SIM cards within the region where the terminal resides as a first virtual SIM card to interact with the server; and clearing registration record information of the local virtual SIM cards corresponding the unsuccessful registrations.

6. The method according to claim 1, wherein the identifier of the local virtual SIM card comprises an international mobile subscriber identity (IMSI); and the registration time comprises a time point of a successful PLMN registration;
the registration record information is classified based on the region where the terminal resides, and local virtual SIM cards within any region are categorized based on priorities, a local virtual SIM card with a top priority is a local virtual SIM card that is successfully registered within a first time period associated with a current time point, and a local virtual SIM card with a second-highest priority is a local virtual SIM card with a successful registration within a second time period associated with the current time point; and
correspondingly, S2 comprises:
selecting a first local virtual SIM card with the top priority corresponding to the successful registration based on the registration record information to interact with the server.

7. The method according to claim 6, further comprising:
periodically checking whether registration record information that exceeds a first predetermined time period is present within a region, and deleting the registration record information that exceeds the first predetermined time period within the region in a case that the registration record information that exceeds the first predetermined time period is present.

8. The method according to claim 1, further comprising:
receiving configuration information sent by the server for configuring the registration record information, and configuring registration record information within the terminal based on the configuration information, wherein the local virtual SIM card in the terminal carries priority information, wherein the configuration information carries the priority information of the local virtual SIM card; wherein
the priority information comprises an identifier of a local virtual SIM card with a top priority and an identifier of a local virtual SIM card with a second-highest priority, wherein the identifier of the local virtual SIM card with the top priority is an identifier of a local virtual SIM card recorded by the server that has achieved a successful registration through interaction with the server and has a shortest interaction time; and
correspondingly, in S2, a first local virtual SIM card with a top priority corresponding to the successful registration based on the registration record information to interact with the server.

9. The method according to claim 1, wherein a plurality of local virtual SIM cards are stored in the terminal;
and/or
a management system where all local virtual SIM cards belong filters registration record information of all terminals managed by the management system, and delivers filtered valid registration record information to terminals that use some or all of the local virtual SIM cards.

10. A terminal, comprising: a memory and a processor;
wherein at least one program is stored in the memory, and the processor is configured to load and run the at least one program stored in the memory to cause the terminal to perform the method according to claim 1.

11. The method according to claim 2, further comprising:
receiving configuration information sent by the server for configuring the registration record information, and configuring registration record information within the terminal based on the configuration information, wherein the local virtual SIM card in the terminal carries priority information, wherein the configuration information carries the priority information of the local virtual SIM card; wherein
the priority information comprises an identifier of a local virtual SIM card with a top priority and an identifier of a local virtual SIM card with a second-highest priority, wherein the identifier of the local virtual SIM card with the top priority is an identifier of a local virtual SIM card recorded by the server that has achieved a successful registration through interaction with the server and has a shortest interaction time; and
correspondingly, in S2, a first local virtual SIM card with a top priority corresponding to the successful registration based on the registration record information to interact with the server.

12. The method according to claim 3, further comprising:
receiving configuration information sent by the server for configuring the registration record information, and configuring registration record information within the terminal based on the configuration information, wherein the local virtual SIM card in the terminal carries priority information, wherein the configuration information carries the priority information of the local virtual SIM card; wherein
the priority information comprises an identifier of a local virtual SIM card with a top priority and an identifier of a local virtual SIM card with a second-highest priority, wherein the identifier of the local virtual SIM card with the top priority is an identifier of a local virtual SIM card recorded by the server that has achieved a successful registration through interaction with the server and has a shortest interaction time; and
correspondingly, in S2, a first local virtual SIM card with a top priority corresponding to the successful registration based on the registration record information to interact with the server.

13. The method according to claim 4, further comprising:
receiving configuration information sent by the server for configuring the registration record information, and configuring registration record information within the terminal based on the configuration information, wherein the local virtual SIM card in the terminal carries priority information, wherein the configuration information carries the priority information of the local virtual SIM card; wherein
the priority information comprises an identifier of a local virtual SIM card with a top priority and an identifier of a local virtual SIM card with a second-highest priority, wherein the identifier of the local virtual SIM card with the top priority is an identifier of a local virtual SIM card recorded by the server that has achieved a successful registration through interaction with the server and has a shortest interaction time; and
correspondingly, in S2, a first local virtual SIM card with a top priority corresponding to the successful registration based on the registration record information to interact with the server.

14. The method according to claim 5, further comprising:
receiving configuration information sent by the server for configuring the registration record information, and configuring registration record information within the terminal based on the configuration information, wherein the local virtual SIM card in the terminal carries priority information, wherein the configuration information carries the priority information of the local virtual SIM card; wherein
the priority information comprises an identifier of a local virtual SIM card with a top priority and an identifier of a local virtual SIM card with a second-highest priority, wherein the identifier of the local virtual SIM card with the top priority is an identifier of a local virtual SIM card recorded by the server that has achieved a successful registration through interaction with the server and has a shortest interaction time; and
correspondingly, in S2, a first local virtual SIM card with a top priority corresponding to the successful registration based on the registration record information to interact with the server.

15. The terminal according to claim 10, wherein the method further comprises:
S2a, in a case that the registration record information is not present, randomly selecting a local virtual SIM card as the first local virtual SIM card to interact with the server, and performing S3 and S4;
wherein in S4, the terminal stores registration information of the first local virtual SIM card based on the information indicating whether the remote virtual SIM card information is successfully received within the specified time period.

16. The terminal according to claim 10, wherein in the method, in a case that in S4 the terminal has not successfully received the remote virtual SIM card information within the specified time period, the method further comprises:
reselecting the first local virtual SIM card corresponding to the successful registration based on the registration record information to interact with the server, and performing S3 and S4.

17. The terminal according to claim 16, wherein the method further comprises:
in a case that local virtual SIM cards corresponding to all successful registrations the registration record information interact with the server but the remote virtual SIM card information fails to be downloaded, selecting a local virtual SIM card from other local virtual SIM cards as a first virtual SIM card to interact with the server; and clearing registration record information of all local virtual SIM cards within the region where the terminal resides.

18. The terminal according to claim 10, wherein the method further comprises:
in a case that all local virtual SIM cards within the region where the terminal resides have registration record information, and the registration record information all indicate unsuccessful registrations, randomly selecting a local virtual SIM card within the region where the terminal resides as a first virtual SIM card to interact with the server; and clearing registration record information of all local virtual SIM cards within the region where the terminal resides;
or
in a case that part of local virtual SIM cards within the region where the terminal resides have registration record information, and the registration record information all indicate unsuccessful registrations, excluding local virtual SIM cards corresponding to the unsuccessful registrations, and randomly selecting a local virtual SIM card from remaining local virtual SIM cards within the region where the terminal resides as a first virtual SIM card to interact with the server; and clearing registration record information of the local virtual SIM cards corresponding the unsuccessful registrations.

19. The terminal according to claim 10, wherein in the method, the identifier of the local virtual SIM card comprises an international mobile subscriber identity (IMSI); and the registration time comprises a time point of a successful PLMN registration;
the registration record information is classified based on the region where the terminal resides, and local virtual SIM cards within any region are categorized based on priorities, a local virtual SIM card with a top priority is a local virtual SIM card that is successfully registered within a first time period associated with a current time point, and a local virtual SIM card with a second-highest priority is a local virtual SIM card with a successful registration within a second time period associated with the current time point; and
correspondingly, S2 comprises:
selecting a first local virtual SIM card with the top priority corresponding to the successful registration based on the registration record information to interact with the server.

20. The terminal according to claim 19, wherein the method further comprises:
periodically checking whether registration record information that exceeds a first predetermined time period is present within a region, and deleting the registration record information that exceeds the first predetermined time period within the region in a case that the registration record information that exceeds the first predetermined time period is present.
